(19) United States
(12) Patent Application Publication
(10) Pub. No.: US 2005/0009945 A1
(43) Pub. Date: Jan. 13, 2005

(54) Radiation-curable powder coating compositions and their use

(75) Inventors: Andreas Wenning, Nottuln (DE); Friedrich Georg Schmidt, Haltern am See (DE); Adolf Kuehnle, Marl (DE); Carsten Jost, Marl (DE); Marielle Wouters, MZ Heeze (NL); Henk van Bracht, GM Eindhoven (NL)

Correspondence Address: OBLON, SPIVAK, MCCLELLAND, MAIER & NEUSTADT, P.C., 1940 DUKE STREET, ALEXANDRIA, VA, 22314, US

(73) Assignee: Degussa AG,, Duesseldorf (DE)

(21) Appl. No.: 10/887,103

(22) Filed: Jul. 9, 2004

(30) Foreign Application Priority Data
Jul. 11, 2003 (DE) 103 31 794.5

(51) Int. Cl. C08G 2/00; C08F 2/46; C08J 3/28

(52) U.S. Cl. 522/148

(57) ABSTRACT

A radiation-curable powder coating composition, contains: I. a binder containing at least one compound crosslinkable by actinic radiation; and II. at least one compound containing polyhedral oligomeric silicon-oxygen cluster units, represented by the formula
[(RₐX_{b}SiO_{1.5})ₘ(R_{c}X_{d}SiO)ₙ(RₑX_{f}Si₂O_{2.5})ₒ(R_{g}XₕSi₂O₂)ₚ] wherein a, b, c=0-1; d=1-2; e, f, g=0-3; h=1-4; m+n+o+p=4; a+b=1; c+d=2; e+f=3 and g+h=4; R=a hydrogen atom, alkyl, cycloalkyl, alkenyl, cycloalkenyl, alkynyl, cycloalkynyl, aryl or heteroaryl group or polymer unit, each of which is substituted or unsubstituted, or further functionalized polyhedral oligomeric silicon-oxygen cluster units, attached via a polymer unit or a bridge unit, X=an oxy, hydroxyl, alkoxy, carboxyl, silyl, alkylsilyl, alkoxysilyl, siloxy, alkylsiloxy, alkoxysiloxy, silylalkyl, alkoxysilylalkyl, alkylsilylalkyl, halo, epoxy, ester, fluoroalkyl, isocyanate, blocked isocyanate, acrylate, methacrylate, nitrile, amino or phosphine group or substituents R containing at least one group X, the substituents R being identical or different and the substituents X being identical or different, and III. auxiliaries and additives.

### BACKGROUND OF THE INVENTION

1. Field of the Invention

The present invention relates to powder coating compositions curable with actinic radiation which have a heightened glass transition temperature and whose crosslinked films exhibit an enhanced hydrophobicity.

2. Discussion of the Background

Actinic radiation means electromagnetic radiation such as X-rays, UV radiation, visible light or near IR (NIR) light, especially UV radiation, or corpuscular radiation such as electron beams.

Interest in powder coating materials curable with actinic radiation is increasing. The reason is the lower thermal load on the substrates, allowing even wood, wood materials, plastics, or certain temperature-sensitive metals or metal alloys, for example, to be coated. Moreover, by virtue of the separation of melting from curing, UV powder coating films have a better surface smoothness than heat-curable powder coating materials. Powder coating materials curable with actinic radiation are described in numerous patents.

EP 667 381 describes solid compositions of a polyglycidyl ether or polyglycidyl ester, mixtures of a polyglycidyl ether or ester with an epoxy resin, and mixtures of a polyglycidyl ether or ester with a cyclic acetal.

EP 636 669 and WO 99/14254 describe two-component radiation-curable powder coating materials based on an unsaturated polyester and a vinyl ether.

U.S. Pat. No. 3,974,303 describes thermoplastic resins containing from 0.5 to 3.5 polymerizable unsaturated groups per 1000 g of molecular weight.

U.S. Pat. No. 5,639,560 describes radiation-curable powder coating compositions comprising special crystalline polyesters, additionally containing methacrylic end groups, as binders.

EP 934 359 describes pulverulent, radiation-curable mixtures of amorphous and crystalline polyesters having terminal methacrylate groups.

EP 1 209 182 and DE 101 63 827 describe radiation-curable powder coating compositions comprising as binder a mixture of at least one amorphous urethane acrylate and at least one crystalline urethane acrylate.

DE 101 63 826 describes UV powder coating compositions having an amorphous urethane acrylate as binder.

DE 101 63 825 describes (semi)crystalline urethane acrylates as binders for powder coating materials which are crosslinkable with actinic radiation.

DE 100 63 159 describes blends of crystalline and amorphous compounds having radiation-activable groups, said blends being solid at room temperature.

A feature common to all powder coating materials curable with actinic radiation is that the glass transition temperature (Tg) of the powders, whose films exhibit very good leveling, adhesion, and elasticity, is unsatisfactory. Moreover, the films produced from these powder coating materials lack hydrophobic properties, meaning that, for instance, water and/or dirt are insufficiently repelled.

### SUMMARY OF THE INVENTION

It is an object of the present invention to provide powder coating compositions curable with actinic radiation which have a relatively high glass transition temperature (Tg) and whose films possess hydrophobic surface properties, without compromising the very good mechanical film properties. This and other objects have been achieved by the present invention the first embodiment of which includes a radiation-curable powder coating composition, comprising:

I. a binder comprising
at least one compound crosslinkable by actinic radiation; and

II. at least one compound comprising polyhedral oligomeric silicon-oxygen cluster units, represented by the formula
[(RₐX_{b}SiO_{1.5})ₘ(R_{c}X_{d}SiO)ₙ(RₑX_{f}Si₂O_{2.5})ₒ(R_{g}XₕSi₂O₂)ₚ]

wherein

a, b, c=0-1; d=1-2; e, f, g=0-3; h=1-4; m+n+o+p=4; a+b=1; c+d=2; e+f=3 and g+h=4;

R=a hydrogen atom, alkyl, cycloalkyl, alkenyl, cycloalkenyl, alkynyl, cycloalkynyl, aryl or heteroaryl group or polymer unit, each of which is substituted or unsubstituted, or further functionalized polyhedral oligomeric silicon-oxygen cluster units, attached via a polymer unit or a bridge unit,

X=an oxy, hydroxyl, alkoxy, carboxyl, silyl, alkylsilyl, alkoxysilyl, siloxy, alkylsiloxy, alkoxysiloxy, silylalkyl, alkoxysilylalkyl, alkylsilylalkyl, halo, epoxy, ester, fluoroalkyl, isocyanate, blocked isocyanate, acrylate, methacrylate, nitrile, amino or phosphine group or substituents R containing at least one group X,

the substituents R being identical or different and the substituents X being identical or different, and

III. auxiliaries and additives.

In addition, the present invention relates to a process for preparing the above radiation-curable powder coating composition, comprising:

admixing components I, II and III in a heatable kneading apparatus and observing an upper temperature limit of 140° C.

In another embodiment, the present invention relates to a process for producing a coating, comprising:

coating the above radiation-curable powder coating on an article.

In yet another embodiment, the present invention relates to a coating produced from the above radiation-curable powder coating composition.

### DETAILED DESCRIPTION OF THE INVENTION

Surprisingly it has been possible to achieve the above object by means of a powder coating composition curable with actinic radiation and comprising a compound having functionalized polyhedral oligomeric silicon-oxygen cluster units.

The present invention provides radiation-curable powder coating compositions, comprising

I. a binder comprising:
at least one compound crosslinkable by actinic radiation; and

II. at least one compound comprising polyhedral oligomeric silicon-oxygen cluster units, in accordance with the formula
[(RₐX_{b}SiO_{1.5})ₘ(R_{c}X_{d}SiO)ₙ(RₑX_{f}Si₂O_{2.5})ₒ(R_{g}XₕSi₂O₂)ₚ]
with a, b, c=0-1; d=1-2; e, f, g=0-3; h=1-4; m+n+o+p≧4; a+b=1; c+d=2; e+f=3 and g+h=4;

R=a hydrogen atom, alkyl, cycloalkyl, alkenyl, cycloalkenyl, alkynyl, cycloalkynyl, aryl or heteroaryl group or polymer unit, each of which is substituted or unsubstituted, or further functionalized polyhedral oligomeric silicon-oxygen cluster units, attached via a polymer unit or a bridge unit,

X=an oxy, hydroxyl, alkoxy, carboxyl, silyl, alkylsilyl, alkoxysilyl, siloxy, alkylsiloxy, alkoxysiloxy, silylalkyl, alkoxysilylalkyl, alkylsilylalkyl, halo, epoxy, ester, fluoroalkyl, isocyanate, blocked isocyanate, acrylate, methacrylate, nitrile, amino or phosphine group or substituents of type R containing at least one such group of type X,

the substituents of type R being identical or different and the substituents of type X being identical or different, and

III. auxiliaries and additives.

The present invention likewise provides for the use of the above compositions for preparing radiation-curable powder coating compositions.

Even further, the present invention provides a process for preparing the above radiation-curable powder coating compositions, in a heatable kneading apparatus, especially extruders, observing an upper temperature limit of 140° C.

The present invention additionally provides a process for producing coatings by using the above radiation-curable powder coating compositions.

The binder I contains at least one low molecular mass, oligomeric or polymeric compound containing on average at least one, preferably at least two, reactive functional group(s) having at least one actinic radiation-activable bond in the molecule. This reactive functional group is referred to below as radiation-activable group. The radiation-activable groups present in the binder I can be identical or different from one another. The binder I possesses a melting point of between 50 and 140° C. It can be amorphous or (semi)crystalline. The melting point of binder I includes all values and subvalues therebetween, especially including 60, 70, 90, 90, 100, 110, 120 and 130° C.

A bond which is activable with actinic radiation becomes reactive when irradiated with actinic radiation and, together with other activated bonds of its kind, enters into polymerization reactions and/or crosslinking reactions. These reactions proceed in accordance with free-radical and/or ionic mechanisms. Examples of suitable bonds are carbon-hydrogen single bonds or carbon-carbon, carbon-oxygen, carbon-nitrogen, carbon-phosphorus or carbon-silicon single bonds or double bonds. Of these, the carbon-carbon double bonds or epoxide groups are particularly advantageous and are therefore used with great preference in accordance with the invention. For the sake of brevity the carbon-carbon double bonds are referred to below as “double bonds”.

Accordingly, particularly advantageous radiation-activable groups contain one double bond or two, three or more double bonds. The double bonds can be conjugated or, with particular advantage, isolated.

Examples of highly suitable radiation-activable groups are acrylate, methacrylate, ethacrylate, crotonate, cinnamate, vinyl ether, vinyl ester, dicyclopentadienyl, norbomenyl, isoprenyl, isopropenyl, allyl or butenyl groups; α,β-unsaturated ester groups; dicyclopentadienyl ether, norbornenyl ether, isoprenyl ether, isopropenyl ether, allyl ether or butenyl ether groups; or dicyclopentadienyl ester, norbornenyl ester, isoprenyl ester, isopropenyl ester, allyl ester or butenyl ester groups. Preferred are acrylate, methacrylate, vinyl ether, vinyl ester, and epoxide groups or α,β-unsaturated ester groups.

Within the binder I, the radiation-activable groups are lateral and/or terminal. Terminal radiation-activable groups generally possess a greater reactivity than lateral groups, owing to the absence of steric shielding. They are therefore used with preference. On the other hand, the reactivity of the binders I can be controlled specifically by way of the proportion of terminal to lateral groups.

If the binder I possesses radiation-activable groups which are different from one another, any desired combinations of the radiation-activable groups are possible.

By way of example, binder I is a urethane acrylate, a urethane methacrylate, an acrylated polyester, a methacrylated polyester, a polyester containing acrylic and methacrylic groups, an unsaturated polyester, an unsaturated polyacrylate, a vinyl ether, a urethane vinyl ether, a vinyl ester, a urethane vinyl ester, a polyglycidyl ether or a polyglycidyl ester. These compounds may be amorphous or (semi)crystalline. Any desired mixtures of these compounds are also possible.

These compounds are described in numerous patents, examples of which include EP 0 667 381, U.S. Pat. No. 3,485,732, EP 0 407 826, EP 0 636 669, WO99/14254, U.S. Pat. Nos. 3,974,303, 5,639,560, EP 0 934 359, EP 1 209 182, DE 101 63 827, DE 101 63 826, DE 101 63 825 and DE 100 63 159.

If the binder I is a urethane acrylate, for example, as described in EP 1 209 182, it is prepared from an amorphous or (semi)crystalline hydroxyl-containing polyester by reaction with polyisocyanates and from a compound which at the same time contains at least one alcohol group and at least one polymerizable acrylate group. These products have both urethane groups and terminal acrylate groups.

The compound II comprises polyhedral oligomeric silicon-oxygen cluster units, in accordance with the formula
[(RₐX_{b}SiO_{1.5})ₘ(R_{c}X_{d}SiO)ₙ(RₑX_{f}Si₂O_{2.5})ₒ(R_{g}XₕSi₂O₂)ₚ]

with a, b, c=0-1; d=1-2; e, f, g=0-3; h=1-4; m+n+o+p≧4; a+b=1; c+d=2; e+f=3and g+h=4;

R=a hydrogen atom, alkyl, cycloalkyl, alkenyl, cycloalkenyl, alkynyl, cycloalkynyl, aryl or heteroaryl group or polymer unit, each of which is substituted or unsubstituted, or further functionalized polyhedral oligomeric silicon-oxygen cluster units, attached via a polymer unit or a bridge unit,

X=an oxy, hydroxyl, alkoxy, carboxyl, silyl, alkylsilyl, alkoxysilyl, siloxy, alkylsiloxy, alkoxysiloxy, silylalkyl, alkoxysilylalkyl, alkylsilylalkyl, halo, epoxy, ester, fluoroalkyl, isocyanate, blocked isocyanate, acrylate, methacrylate, nitrile, amino or phosphine group or substituents of type R containing at least one such group of type X,

the substituents of type R being identical or different and the substituents of type X being identical or different.

A polyhedral oligomeric silicon-oxygen cluster preferably connotes the two classes of compound of the silsesquioxanes and of the spherosilicates.

Silsesquioxanes are oligomeric or polymeric substances whose completely condensed representatives possess the general formula (SiO_{3/2}R)ₙ, where n≧4 and the radical R can be a hydrogen atom but is usually an organic radical. The smallest structure of a silsesquioxane is the tetrahedron. Voronkov and Lavrent'yev (Top. Curr. Chem. 102 (1982), 199-236) describe the synthesis of completely and of incompletely condensed oligomeric silsesquioxanes by hydrolytic condensation of trifunctional RSiY₃ precursors, where R is a hydrocarbon radical and Y is a hydrolyzable group, such as chloride, alkoxide or siloxide, for example. Lichtenhan et al. describe the base-catalyzed preparation of oligomeric silsesquioxanes (WO 01/10871). Silsesquioxanes of the formula R₈Si₈O₁₂ (with identical or different hydrocarbon radicals R) can be reacted with base catalysis to functionalized, incompletely condensed silsesquioxanes, such as R₇Si₇O₉(OH)₃ or else R₈Si₈O₁₁(OH)₂ and R₈Si₈O₁₀(OH)₄, for example (Chem. Commun. (1999), 2309-10; Polym. Mater. Sci. Eng. 82 (2000), 301-2; WO 01/10871), and hence may serve as a parent compound for a multiplicity of different incompletely condensed and functionalized silsesquioxanes. The silsesquioxanes (trisilanols) of the formula R₇Si₇O₉(OH)₃ in particular can be reacted with functionalized monomeric silanes (corner capping) and so converted into correspondingly modified oligomeric silsesquioxanes.

If the compound II comprising polyhedral oligomeric silicon-oxygen clusters is from the class of compounds of the silsesquioxanes, they possess the following formula:
[(RₐX_{b}SiO_{1.5})ₘ(R_{c}X_{d}SiO)ₙ] with a, b, c=0-1; d=1-2; m+n≧4; a+b=1; c+d=2.

Preference is given to compounds which are functionalized and whose functionalized polyhedral oligomeric silicon-oxygen cluster unit is based essentially on structure 1

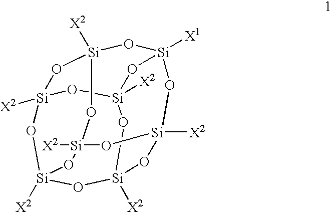

with X¹=substituent of type X or of type —O—SiX₃, and X²=substituent of type X, of type —O—SiX₃, of type R, of type —O—SiX₂R, of type —O—SiXR₂ or of type —O—SiR₃,

R=a hydrogen atom, alkyl, cycloalkyl, alkenyl, cycloalkenyl, alkynyl, cycloalkynyl, aryl or heteroaryl group or polymer unit, each of which is substituted or unsubstituted, or further functionalized polyhedral oligomeric silicon-oxygen cluster units attached via a polymer unit or a bridge unit, and

X=an oxy, hydroxyl, alkoxy, carboxyl, silyl, alkylsilyl, alkoxysilyl, siloxy, alkylsiloxy, alkoxysiloxy, silylalkyl, alkoxysilylalkyl, alkylsilylalkyl, halo, epoxy, ester, fluoroalkyl, isocyanate, blocked isocyanate, acrylate, methacrylate, nitrile, amino or phosphine group or substituents of type R containing at least one such group of type X.

Preference is also given to compounds based essentially on the functionalized oligomeric silsesquioxane unit of structure 2, 3 or 4 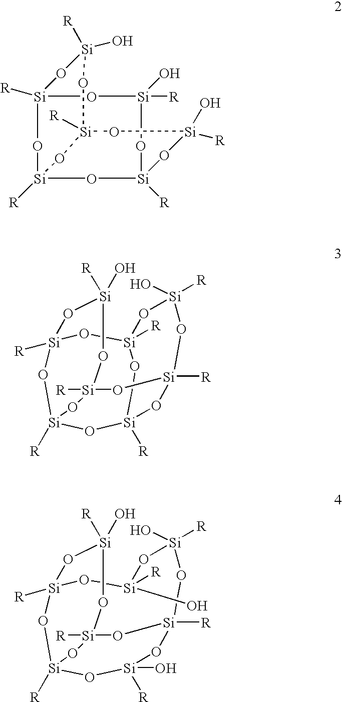
with R=a hydrogen atom or alkyl, cycloalkyl, alkenyl, cycloalkenyl, alkynyl, cycloalkynyl, aryl or heteroaryl group or polymer unit, each of which is substituted or unsubstituted, or further functionalized oligomeric silsesquioxane units attached via a polymer unit or a bridge unit, the silsesquioxane unit being functionalized via at least one hydroxyl group.

The substituents of type R of the silsesquioxane units can all be identical, producing what is called a functionalized homoleptic structure thus
[(RSiO_{1.5})ₘ(RXSiO)ₙ]

with m +n=z and z≧4, z corresponding to the number of silicon atoms in the framework structure of the polyhedral oligomeric silicon-oxygen cluster unit, and R=a hydrogen atom, alkyl, cycloalkyl, alkenyl, cycloalkenyl, alkynyl, cycloalkynyl, aryl or heteroaryl group or polymer unit, each of which is substituted or unsubstituted, or further functionalized polyhedral oligomeric silicon-oxygen cluster units, attached via a polymer unit or a bridge unit,

X=an oxy, hydroxyl, alkoxy, carboxyl, silyl, alkylsilyl, alkoxysilyl, siloxy, alkylsiloxy, alkoxysiloxy, silylalkyl, alkoxysilylalkyl, alkylsilylalkyl, halo, epoxy, ester, fluoroalkyl, isocyanate, blocked isocyanate, acrylate, methacrylate, nitrile, amino or phosphine group or substituents of type R containing at least one such group of type X, the substituents of type R being identical or different and the substituents of type X being identical or different.

In a further embodiment of the crosslinker it is possible for at least two of the substituents of type R to be different, in which case the crosslinker is said to have a functionalized heteroleptic structure thus
[(RSiO_{1.5})ₘ(R′XSiO)ₙ]

with m+n=z and z≧4, z corresponding to the number of silicon atoms in the framework structure of the polyhedral oligomeric silicon-oxygen cluster unit, and R=a hydrogen atom, alkyl, cycloalkyl, alkenyl, cycloalkenyl, alkynyl, cycloalkynyl, aryl or heteroaryl group or polymer unit, each of which is substituted or unsubstituted, or further functionalized polyhedral oligomeric silicon-oxygen cluster units, attached via a polymer unit or a bridge unit,

X=an oxy, hydroxyl, alkoxy, carboxyl, silyl, alkylsilyl, alkoxysilyl, siloxy, alkylsiloxy, alkoxysiloxy, silylalkyl, alkoxysilylalkyl, alkylsilylalkyl, halo, epoxy, ester, fluoroalkyl, isocyanate, blocked isocyanate, acrylate, methacrylate, nitrile, amino or phosphine group or substituents of type R containing at least one such group of type X, the substituents of type R being identical or different and the substituents of type X being identical or different.

Very particular preference is given to functionalized oligomeric silsesquioxanes of structure 5

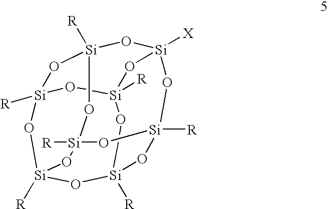

with R=a hydrogen atom, alkyl, cycloalkyl, alkenyl, cycloalkenyl, alkynyl, cycloalkynyl, aryl or heteroaryl group or polymer unit, each of which is substituted or unsubstituted, or further functionalized polyhedral oligomeric silicon-oxygen cluster units, attached via a polymer unit or a bridge unit,

X=an oxy, hydroxyl, alkoxy, carboxyl, silyl, alkylsilyl, alkoxysilyl, siloxy, alkylsiloxy, alkoxysiloxy, silylalkyl, alkoxysilylalkyl, alkylsilylalkyl, halo, epoxy, ester, fluoroalkyl, isocyanate, blocked isocyanate, acrylate, methacrylate, nitrile, amino or phosphine group or substituents of type R containing at least one such group of type X,

the substituents of type R being identical or different and the substituents of type X being identical or different.

Likewise particularly preferred are compounds whose polyhedral oligomeric silicon-oxygen cluster units are nonfunctionalized oligomeric silsesquioxane units.

Oligomeric spherosilicates have a construction similar to that of the oligomeric silsesquioxanes. They too possess a “cagelike” structure. Unlike the silsesquioxanes, owing to the method by which they are prepared, the silicon atoms at the comers of a spherosilicate are connected to a further oxygen atom, which in turn is further substituted. Oligomeric spherosilicates can be prepared by silylating suitable silicate precursors (D. Hoebbel, W. Wieker, Z. Anorg. Allg. Chem. 384 (1971), 43-52; P. A. Agaskar, Colloids Surf. 63 (1992), 131-8; P. G. Harrison, R. Kannengiesser, C. J. Hall, J. Main Group Met. Chem. 20 (1997), 137-141; R. Weidner, Zeller, B. Deubzer, V. Frey, Ger. Offen. (1990), DE 38 37 397). For example, the spherosilicate with structure 7 can be synthesized from the silicate precursor of structure 6, which in turn is obtainable by the reaction of Si(OEt)₄ with choline silicate or by the reaction of waste products from the harvesting of rice with tetrarnethylammonium hydroxide (R. M. Laine, I. Hasegawa, C. Brick, J. Kampf, Abstracts of Papers, 222nd ACS National Meeting, Chicago, Ill., United States, Aug. 26-30, 2001, MTLS-018).

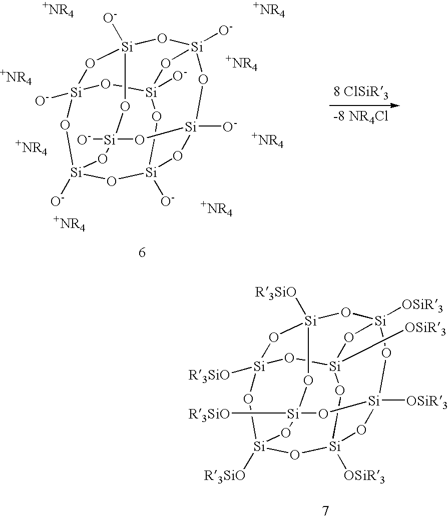

If the compound II comprising polyhedral oligomeric silicon-oxygen clusters is from the class of compounds of the spherosilicates, they possess the following formula:
[(RₑX_{f}Si₂O_{2.5})ₒ(R_{g}XₕSi₂O₂)ₚ] with e, f, g=0-3; h=1-4; o+p≧4; e+f=3, and g+h=4.

Preferred compounds are those whose polyhedral oligomeric silicon-oxygen cluster units are functionalized oligomeric spherosilicate units.

Likewise preferred are compounds whose polyhedral oligomeric silicon-oxygen cluster units are nonfunctionalized oligomeric spherosilicate units.

Both the silsesquioxanes and the spherosilicates are thermally stable at temperatures of up to several hundred degrees Celsius.

The class of compound of the silsesquioxanes is employed with particular preference.

Further information relating to the functionalized compounds II containing polyhedral oligomeric silicon-oxygen cluster units, concerning their synthesis, for example, is described in, for example, DE 102 20 853.0 and DE 103 01 754.2.

The powder coating composition of the invention is suitably radiation-cured with electromagnetic radiation such as X-rays, UV radiation, visible light or near IR (NIR) light, especially UV radiation, or corpuscular radiation such as electron beams.

Where accelerated electron beams are used free radicals are generated from the powder coating composition in a number which ensures extremely rapid polymerization of the reactive acrylate groups. It is preferred to use radiation doses of from 5 to 15 Mrad. The radiation dose includes all values and subvalues therebetween, especially including 6, 7, 8, 9, 10, 11, 12, 13 and 14 Mrad.

In the case of UV curing, use is made, as further, necessary ingredients III, of UV initiators, which are known in principle from conventional liquid UV-curing systems, e.g., EP 633 912. These are substances which on irradiation with UV light break down into free radicals and so initiate the polymerization. Examples of suitable UV initiators include 2,2′-diethoxyacetophenone, hydroxycyclohexyl phenyl ketone, benzophenone, 2-hydroxy-2-methyl-1-phenylpropan-1-one, xanthone, thioxanthone, benzil dimethyl ketal, and so on. UV initiators of this kind are sold commercially, e.g., IRGACURE 184 or DEGACURE 1173 from Ciba. As a proportion of the overall system the amount of the photoinitiator is from about 0.5 to 5% by weight. The amount of photoinitiator includes all values and subvalues therebetween, especially including 1, 1.5, 2, 2.5, 3, 3.5, 4 and 4.5% by weight.

The use of initiators, e.g., thioxanthones, phosphine oxides, metallocenes, tertiary aminobenzenes or tertiary aminobenzophenones, which break down into free radicals on irradiation with visible light is also possible.

Optional additives III are acrylate- or methacrylate-containing compounds, such as the triacrylate of tris(2-hydroxyethyl) isocyanurate (SR 386, Sartomer), for example, and adhesion promoters, which can be used in minor proportions of 0-20% by weight in order to modify the coating properties. The amount of optional additives includes all values and subvalues therebetween, especially including 1, 2, 3, 4, 5, 6, 7, 8, 9, 10, 11, 12, 13, 14, 15, 16, 17, 18 and 19% by weight.

Further additives III commonly employed for powder coating materials include leveling agents, light stabilizers, and devolatilizers. They can be used at from 0-5% by weight. The amount of further additives includes all values and subvalues therebetween, especially including 0.5, 1, 1.5, 2, 2.5, 3, 3.5, 4 and 4.5 % by weight. It is additionally possible to employ pigments and fillers, examples being metal oxides such as titanium dioxide, and metal hydroxides, sulfates, sulfides, carbonates, silicates, talc, carbon black, etc., in weight fractions of from 0-50%. The amount of pigments and fillers includes all values and subvalues therebetween, especially including 5, 10, 15, 20, 25, 30, 35, 40 and 45% by weight.

To prepare the ready-to-use powder coating composition the ingredients are mixed. The ingredients can be homogenized in suitable equipment, such as heatable kneading apparatus, for example, but preferably by extrusion, in the course of which upper temperature limits of 140° C., preferably from 120-130° C., ought not to be exceeded. The temperature during kneading includes all values and subvalues therebetween, especially including 100, 105, 110, 115, 120, 125, 130 and 135° C. After it has been cooled to room temperature and appropriately comminuted, the extruded mass is ground without adding coolants to form the ready-to-spray powder. Application of this powder to appropriate substrates can take place in accordance with the known techniques, such as, for example, by electrostatic or tribostatic powder spraying, or fluid-bed sintering, with or without electrostatic assistance. Examples of suitable substrates include untreated or pretreated metallic substrates, wood, wood materials, plastics, glass, and paper.

The powder coating compositions of the invention have an increased glass transition temperature. The coatings produced from the powder coating compositions of the invention are flexible and hard, adhere well, and possess a hydrophobic surface. The invention additionally provides coatings of the type described.

Having generally described this invention, a further understanding can be obtained by reference to certain specific examples which are provided herein for purposes of illustration only, and are not intended to be limiting unless otherwise specified.

### EXAMPLES

1. Instructions for preparing the amorphous urethane acrylate

65 kg of isophthalic acid, 6 kg of monoethylene glycol, 19 kg of neopentyl glycol and 26 kg of cyclohexanedimethanol were admixed with 0.2 percent by mass of n-butyltin trioctanoate and heated to 190° C. under nitrogen and with stirring in an apparatus provided with a distillation column. In the course of the removal of water this temperature was slowly raised to 230° C. After about 98% of the theoretical amount of water had been distilled off, the product was added at 120° C. in portions, with vigorous stirring, to a mixture of 3.2 kg of a 1:1 adduct of IPDI and hydroxyethyl acrylate, 0.7 kg of IONOL CP and 0.2 kg of dibutyltin dilaurate. After about one hour of stirring the NCO content was below 0.1%. The hot reaction mixture was poured from the flask onto a sheet. As soon as the reaction mass had solidified and cooled, it was mechanically comminuted and ground. The melting range of this product was 82 to 86° C.

2. Preparation of the crystalline urethane acrylate

230 kg of dodecanedioc acid and 66 kg of monoethylene glycol were admixed with 0.2 percent by mass of n-butyltin trioctanoate and heated to 190° C. under nitrogen and with stirring in an apparatus provided with a distillation column. In the course of the removal of water this temperature was slowly raised to 230° C. After about 98% of the theoretical amount of water had been distilled off, the product was added at 120° C. in portions, with vigorous stirring, to a mixture of 63 kg of a 1:1 adduct of IPDI and hydroxyethyl acrylate, 3.2 kg of IONOL CP and 0.6 kg of dibutyltin dilaurate. After about one hour of stirring the NCO content was below 0.1%. The hot reaction mixture was poured from the flask onto a sheet. As soon as the reaction mass had solidified and cooled, it was mechanically comminuted and ground. The melting point of this product was 77° C.

3 . Preparation of the silsesquioxane (isobutyl)₈Si₈O₁₂

Added with stirring to a solution of 446 g of isobutyltrimethoxysilane (isobutyl)Si(OMe)₃ in 4300 ml of acetone was a solution of 6.4 g of KOH in 200 ml of H₂O. The reaction mixture was subsequently stirred at 30° C. for 3 days. The precipitate formed was isolated by filtration and dried under reduced pressure at 70° C. The product, (isobutyl)₈Si₈O₁₂, was obtained in a yield of 262 g (96%).

4. Preparation of the inventive powder coating compositions

850 g of the amorphous urethane acrylate from Example 1 and 150 g of the crystalline urethane acrylate from Example 2 were admixed with 7 g of BYK 361 (leveling agent, BYK Chemie), 10 g of Worlée Add 900 (devolatilizer, Worlée-Chemie), 10 g of EBECRYL 170 (adhesion promoter, UCB), 10 g of Irgacure 2959 (photoinitiator, Ciba Specialty Chemicals) and 50 parts of the silsesquioxane (isobutyl)₈Si₈O₁₂ from Example 3. The comminuted ingredients were intimately mixed in an edge runner mill and the mixture was subsequently homogenized in an extruder at up to 130° C. maximum. After cooling, the extrudate was fractionated and ground using a pinned-disk mill to a particle size <100 μm, with coolants (liquid nitrogen or dry ice) in the case of the comparative example and without them in the case of the inventive example. The powder produced in this way was applied to degreased standard steel and to MDF (medium-density fiberboard) panels using an electrostatic powder spraying unit at 60 kV. The powder was then melted under IR irradiation and the melt film cured using UV radiation (Hg lamp, approximately 3000 mJ/cm²).

5. Preparation of the powder coating composition without silsesquioxane (comparative)

The powder coating composition was prepared in analogy to the inventive powder coating composition from Example 4. However, the addition of the silsesquioxane (isobutyl)₈Si₈O₁₂ from Example 3 was omitted.

The test results are summarized in Table 1:

TABLE 1

| | | | | | Ball impact | | |
|---|---|---|---|---|---|---|---|
| | Tg powder¹ | | | | d./i.⁴ | | Contact |
| Example | (° C.) | Substrate | HK² [sec] | ET³ [mm] | [inch · lb] | CC⁵ | angle⁶ [°] |
| 4 | 30 | Standard steel | 172 | >10 | >80 />80 | 0 | 115 |
| 4 | 30 | MDF | 146 | — | — | 0 | 115 |
| 5 | 20 | Standard steel | 173 | >10 | >80 />80 | 0 | 94 |
| (comparative) | | | | | | | |
| 5 | 20 | MDF | 157 | — | — | 0 | 94 |
| (comparative) | | | | | | | |

¹Glass transition temperature (DSC)
²König hardness (DIN 53 157)
³Erichsen cupping (DIN 53 156)
⁴Impact indentation, direct/indirect (ASTM D 2794-93)
⁵Cross-cut (DIN 53153, ISO 2409) (scale 0 (no loss of adhesion) to 5 (total loss of adhesion))
⁶Contact angle with a 60 μl water drop

The powder coating composition from Example 4 (according to the present invention) has a higher glass transition temperature, owing to the addition of the silsesquioxane. The surface of the crosslinked film is hydrophobic. Consequently the powder coating possesses a water repellency effect. The mechanical coating properties, such as hardness, flexibility, and adhesion, are unaffected by the silsesquioxane. They remain at the very high level. The noninventive Comparative Example 5 has weaknesses in particular in the grindability of the powder and also in the hydrophobicity of the coating.

German patent application 103 31794.5 filed Jul. 11, 2003, is incorporated herein by reference.

Numerous modifications and variations on the present invention are possible in light of the above teachings. It is therefore to be understood that within the scope of the appended claims, the invention may be practiced otherwise than as specifically described herein.

1. A radiation-curable powder coating composition, comprising:
I. a binder comprising
at least one compound crosslinkable by actinic radiation; and
II. at least one compound comprising polyhedral oligomeric silicon-oxygen cluster units, represented by the formula
[(RₐX_{b}SiO_{1.5})ₘ(R_{c}X_{d}SiO)ₙ(RₑX_{f}Si₂O_{2.5})ₒ(R_{g}XₕSi₂O₂)ₚ]
wherein
a, b, c=0-1; d=1-2; e, f, g=0-3; h=1-4; m+n+o+p=4; a+b=1; c+d=2; e+f=3 and g+h=4;
R=a hydrogen atom, alkyl, cycloalkyl, alkenyl, cycloalkenyl, alkynyl, cycloalkynyl, aryl or heteroaryl group or polymer unit, each of which is substituted or unsubstituted, or further functionalized polyhedral oligomeric silicon-oxygen cluster units, attached via a polymer unit or a bridge unit,
X=an oxy, hydroxyl, alkoxy, carboxyl, silyl, alkylsilyl, alkoxysilyl, siloxy, alkylsiloxy, alkoxysiloxy, silylalkyl, alkoxysilylalkyl, alkylsilylalkyl, halo, epoxy, ester, fluoroalkyl, isocyanate, blocked isocyanate, acrylate, methacrylate, nitrile, amino or phosphine group or substituents R containing at least one group X,
the substituents R being identical or different and the substituents X being identical or different, and
III. auxiliaries and additives.

2. The radiation-curable powder coating composition as claimed in claim 1, wherein the binder I comprises at least one compound containing on average at least one reactive functional group(s) having at least one actinic-radiation activable bond in the molecule.

3. The radiation-curable powder coating composition as claimed in claim 1, wherein the binder I comprises at least one compound which is of low molecular mass and/or oligomeric and/or polymeric.

4. The radiation-curable powder coating composition as claimed in claim 2, wherein the actinic-radiation-activable bonds are selected from the group consisting of carbon-hydrogen single bonds, carbon-carbon single bonds, carbon-oxygen single bonds, carbon-nitrogen single bonds, carbon-phosphorus single bonds, carbon-silicon single bonds, carbon-carbon double bonds, carbon-oxygen double bonds, carbon-nitrogen double bonds, carbon-phosphorus double bonds and carbon-silicon double bonds.

5. The radiation-curable powder coating composition as claimed in claim 2, wherein the reactive functional groups are selected from the group consisting of acrylate, methacrylate, ethacrylate, crotonate, cinnamate, vinyl ether, vinyl ester, dicyclopentadienyl, norbomenyl, isoprenyl, isopropenyl, allyl, and butenyl groups; unsaturated ester groups; dicyclopentadienyl ether, norbornenyl ether, isoprenyl ether, isopropenyl ether, allyl ether, butenyl ether; dicyclopentadienyl ester, norbornenyl ester, isoprenyl ester, isopropenyl ester, allyl ester, and butenyl ester.

6. The radiation-curable powder coating composition as claimed in claim 2, wherein the reactive functional groups are selected from the group consisting of acrylate, methacrylate, vinyl ether, vinyl ester, epoxide and α,β-unsaturated ester.

7. The radiation-curable powder coating composition as claimed in claim 2, wherein the reactive functional groups are lateral and/or terminal in the binder I.

8. The radiation-curable powder coating composition as claimed in claim 1, wherein the binder I is a urethane acrylate, a urethane methacrylate, an acrylated polyester, a methacrylated polyester, a polyester containing acrylic, methacrylic groups, an unsaturated polyester, an unsaturated polyacrylate, a vinyl ether, a urethane vinyl ether, a vinyl ester, a urethane vinyl ester, a polyglycidyl ether, a polyglycidyl ester and mixtures thereof.

9. The radiation-curable powder coating composition as claimed in claim 1, wherein the binder I is amorphous.

10. The radiation-curable powder coating composition as claimed in claim 1, wherein the binder I is (semi)crystalline.

11. The radiation-curable powder coating composition as claimed in claim 1, wherein the binder I is an amorphous and/or (semi)crystalline urethane acrylate synthesized by reacting the following components:
a) at least one amorphous and/or (semi)crystalline hydroxyl-containing polyester,
b) at least one polyisocyanate,
c) at least one compound containing at least one alcohol group and at least one polymerizable acrylate group.

12. The radiation-curable powder coating composition as claimed in claim 1, wherein the polyhedral oligomeric silicon-oxygen cluster unit is functionalized and wherein substituent X contains a functional group.

13. The radiation-curable powder coating composition as claimed in claim 1, wherein at least one of the substituents X contains an amino group.

14. The radiation-curable powder coating composition as claimed in claim 1, wherein at least one of the substituents X contains an isocyanate or blocked isocyanate group.

15. The radiation-curable powder coating composition as claimed in claim 1, wherein at least one of the substituents X contains an acrylate or methacrylate group.

16. The radiation-curable powder coating composition as claimed in claim 1, wherein at least one of the substituents X contains an alkoxysilyl or alkoxysilylalkyl group.

17. The radiation-curable powder coating composition as claimed in claim 1, wherein at least one of the substituents X contains an epoxy group.

18. The radiation-curable powder coating composition as claimed in claim 1, wherein at least one of the substituents X contains a hydroxyl group.

19. The radiation-curable powder coating composition as claimed in claim 1, wherein at least two of the substituents are X.

20. The radiation-curable powder coating composition as claimed in claim 1, wherein at least two of the substituents X are identical.

21. The radiation-curable powder coating composition as claimed in claim 1, wherein the functionalized polyhedral oligomeric silicon-oxygen cluster unit is based on structure 1 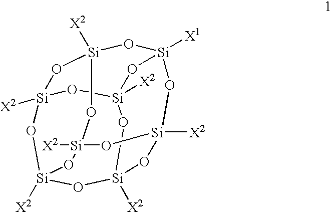
wherein X¹=substituent X or —O—SiX₃, and X²=substituent X, —O—SiX₃, R, —O—SiX₂R, —O—SiXR₂ or —O—SiR₃.

22. The radiation-curable powder coating composition as claimed in claim 1, wherein the functionalized polyhedral oligomeric silicon-oxygen cluster unit is a functionalized oligomeric silsesquioxane unit.

23. The radiation-curable powder coating composition as claimed in claim 22, wherein the silsesquioxane unit has a functionalized homoleptic structure, all substituents R being identical.

24. The radiation-curable powder coating composition as claimed in claim 22, wherein the silsesquioxane unit has a functionalized heteroleptic structure, at least two of the substituents R being different.

25. The radiation-curable powder coating composition as claimed in claim 22, wherein the functionalized oligomeric silsesquioxane unit is obtained by reacting silsesquioxane units having free hydroxyl groups with monomeric functionalized silanes of the structure Y₃Si—X¹, Y₂SiX¹X², and YSiX¹X²X³, the substituent Y being a leaving group selected from alkoxy, carboxyl, halo, silyloxy, and amino groups, and the substituents X¹, X², and X³ being X and being identical or different.

26. The radiation-curable powder coating composition as claimed in claim 1, wherein the functionalized oligomeric silsesquioxane unit is based on structure 2, 3 or 4:

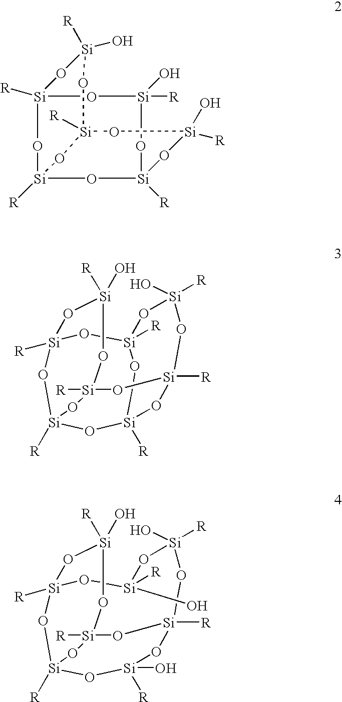

27. A radiation-curable powder coating composition as claimed in claim 1, wherein the functionalized oligomeric silsesquioxane unit is based on structure 5 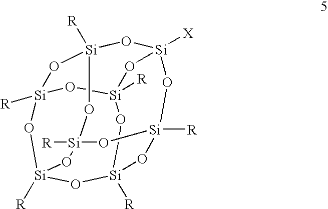
wherein
R=a hydrogen atom, alkyl, cycloalkyl, alkenyl, cycloalkenyl, alkynyl, cycloalkynyl, aryl or heteroaryl group or polymer unit, each of which is substituted or unsubstituted, or further functionalized polyhedral oligomeric silicon-oxygen cluster units, attached via a polymer unit or a bridge unit,
X=an oxy, hydroxyl, alkoxy, carboxyl, silyl, alkylsilyl, alkoxysilyl, siloxy, alkylsiloxy, alkoxysiloxy, silylalkyl, alkoxysilylalkyl, alkylsilylalkyl, halo, epoxy, ester, fluoroalkyl, isocyanate, blocked isocyanate, acrylate, methacrylate, nitrile, amino or phosphine group or substituents R containing at least one substituent X,
the substituents R being identical or different and the substituents X being identical or different.

28. The radiation-curable powder coating composition as claimed in claim 1, wherein the polyhedral oligomeric silicon-oxygen cluster unit is a nonfunctionalized oligomeric silsesquioxane unit.

29. The radiation-curable powder coating composition as claimed in claim 1, wherein the functionalized polyhedral oligomeric silicon-oxygen cluster unit is a functionalized oligomeric spherosilicate unit.

30. The radiation-curable powder coating composition as claimed in claim 1, wherein the polyhedral oligomeric silicon-oxygen cluster unit is a nonfunctionalized oligomeric spherosilicate unit.

31. The radiation-curable powder coating composition as claimed in claim 1, comprising:
at least one compound selected from the group consisting of UV initiators, leveling agents, light stabilizers, devolatilizers, pigments, fillers, adhesion promoters, acrylate-containing compounds, methacrylate-containing compounds and mixtures thereof.

32. A process for preparing a radiation-curable powder coating composition according to claim 1, comprising:
admixing components I, II and III in a heatable kneading apparatus and observing an upper temperature limit of 140° C.

33. A process for producing a coating, comprising:
coating the radiation-curable powder coating according to claim 1 on an article.

34. A coating produced from a radiation-curable powder coating composition as claimed in claim 1.
